(19) United States
(12) Patent Application Publication
(10) Pub. No.: US 2009/0006745 A1
(43) Pub. Date: Jan. 1, 2009

(54) Accessing snapshot data image of a data mirroring volume

(76) Inventors: Joseph S. Cavallo, Waltham, MA (US); Brian Leete, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/823,857

(22) Filed: Jun. 28, 2007

(51) Int. Cl. G06F 12/00

(52) U.S. Cl. 711/114; 711/E12.001

(57) ABSTRACT

Methods and apparatus relating to accessing snapshot data image of a data mirroring volume are described. In one embodiment, a host computer is allowed to access a first data volume and a second data volume. The second data volume may comprise data corresponding to a snapshot image of the first data volume prior to a suspension of data mirroring. Other embodiments are also disclosed.

### BACKGROUND

The present disclosure generally relates to the field of electronics. More particularly, an embodiment of the invention generally relates to accessing snapshot data image of a data mirroring volume.

In data storage, data mirroring may be used to replicate data on more than one storage disk. For example, a Redundant Array of Independent Drives (or Disks), also known as Redundant Array of Inexpensive Drives (or Disks) (RAID) level 1 (or RAID-1) may be used for fault tolerance resulting from disk errors.

Generally, a RAID-1 array continues to operate as long as at least one disk is functioning. Furthermore, in RAID-1, each storage disk of the mirrored set is part of a single RAID volume. Hence, a host computer accesses the RAID volume itself and not the individual data mirror disks. If data mirroring of a RAID-1 array is broken, the RAID volume may still remain operational by using one of its active disks.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1A through 2 illustrate block diagrams of disk mirroring systems, according to some embodiments.

FIG. 3 illustrates a flow diagram of a method according to an embodiment.

FIG. 4 illustrates a block diagram of an embodiment of a computing system, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Some of the embodiments discussed herein may enable access to a snapshot data image of a data mirroring volume, e.g., after data mirroring is disrupted. In various embodiments, data mirroring may be disrupted due to a suspension (e.g., in response to a command generated by a user or host computer) and/or an error (e.g., a read or write error of a disk that is a member of a data mirroring set). As discussed herein, the term “volume” may generally refer to a logical storage volume that may correspond to a set of mirrored disks (e.g., two or more disks). Also, even though some embodiments discussed herein may refer to various disks that are members of a data mirroring set (e.g., forming a RAID-1 mirroring set), each of the disks may be disk partitions within a single physical disk drive. Alternatively, the disks may be disk partitions spanned across a plurality of physical disk drives. Hence, the use of the term “disk” or “disk partition” herein may be interchangeable.

Furthermore, the usage of the term “disk” herein is intended to refer to any collection of data, whether stored in physical disk drive or logically accessible through a link (such as network connected drives, or some other physical media that may or may not be a drive such as flash connected to a host computer via Open NAND Flash Interface (ONFI)). Thus, the data mirroring is intended to include any form of data replication, and the ability to break and restore the mirror. Moreover, a disk is intended to be any collection of data that appears as a disk drive to hardware (e.g., a flash based solid state drive), or may be something that emulates a drive in software (such as flash on ONFI with a driver that emulates a drive).

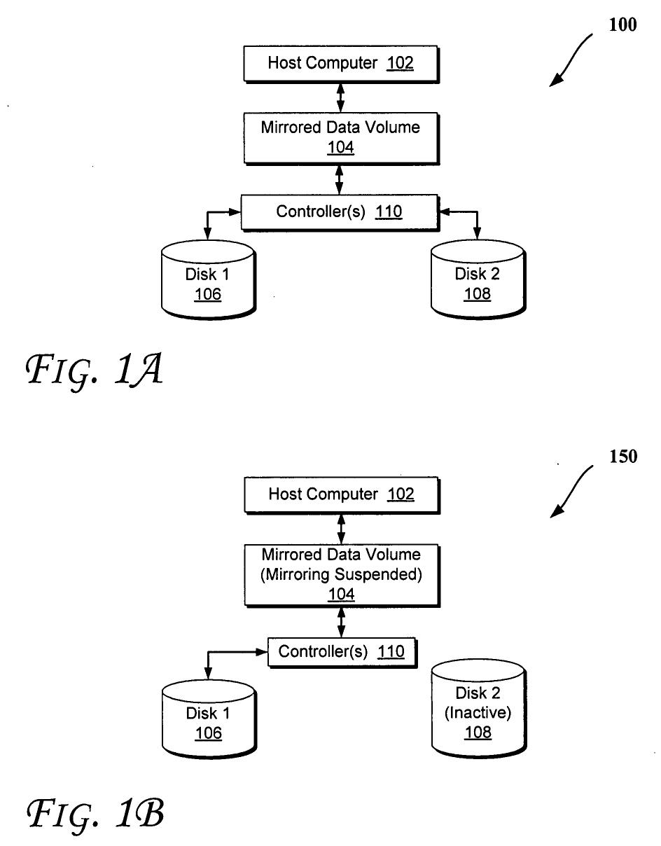

More particularly, FIG. 1A illustrates a block diagram of a disk mirroring system 100, according to one embodiment. The system 100 may include a host computer 102, a mirrored data volume 104, and one or more disks 106 and 108. In one embodiment, disks 106 and 108 may form a disk mirroring set (e.g., corresponding to a RAID-1 set) to store data read or written by the host computer 102. More than two disks may be utilized in some embodiments to form a data mirroring set.

As shown in FIG. 1A, the host computer 102 may access the disks 106 and/or 108 through the mirrored data volume 104. In one embodiment, the mirrored data volume 104 may be a logical representation of the disks 106 and 108 to the host computer 102. Furthermore, during normal mirroring operations, the disks 106 and 108 may store identical (mirrored) data.

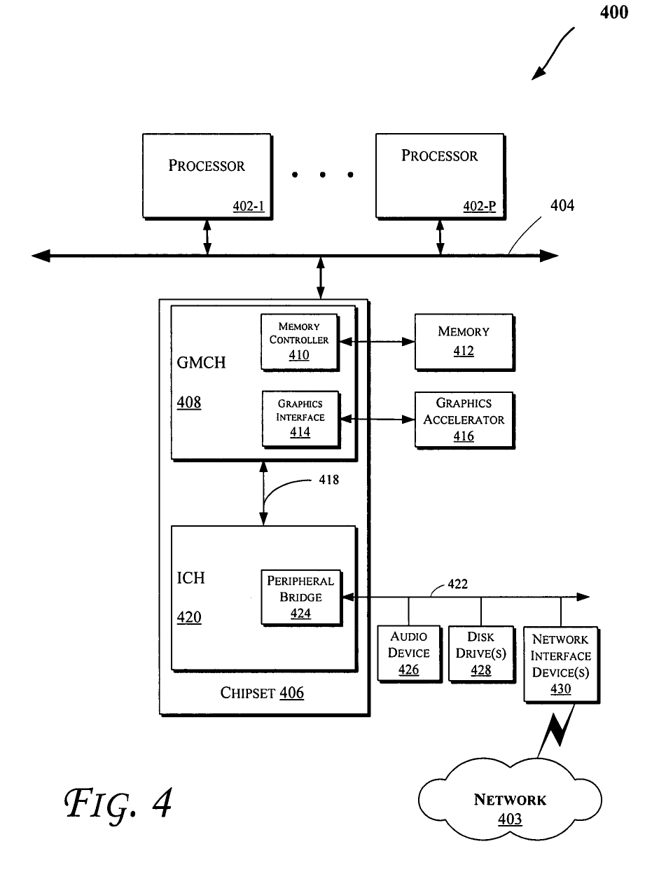

As will be further discussed with reference to FIG. 4, the disks 106 and 108 may communicate with the host computer 102 via the same or different communication protocols. Further, each of the disks 106 and 108 may be an Integrated Drive Electronics (IDE) disk, enhanced IDE (EIDE) disk, Small Computer System Interface (SCSI) disk, Serial Advanced Technology Attachment (SATA) disk, Fibre Channel disk, SAS (Serial Attached SCSI) disk, universal serial bus (USB) disk, Internet SCSI (iSCSI), etc. Also, the disks 106 and 108 may communicate with the host computer 102 via the same or different disk controllers 110 (complying with the aforementioned configurations, for example).

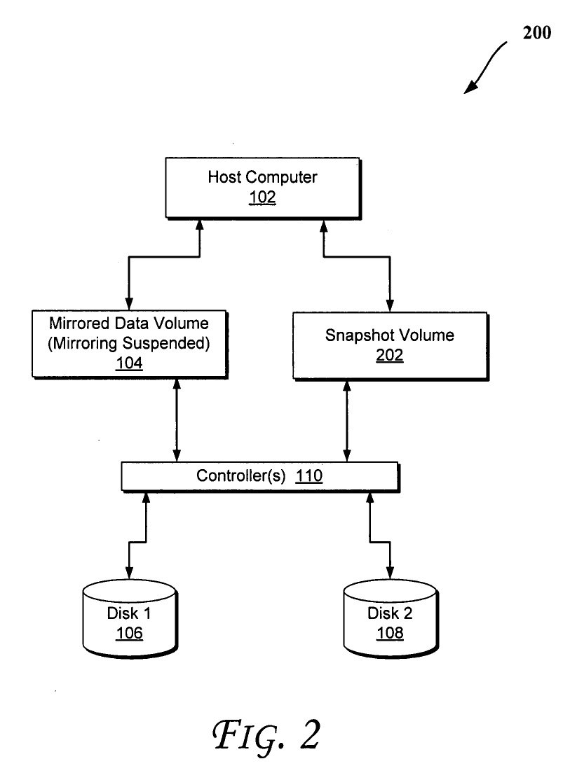

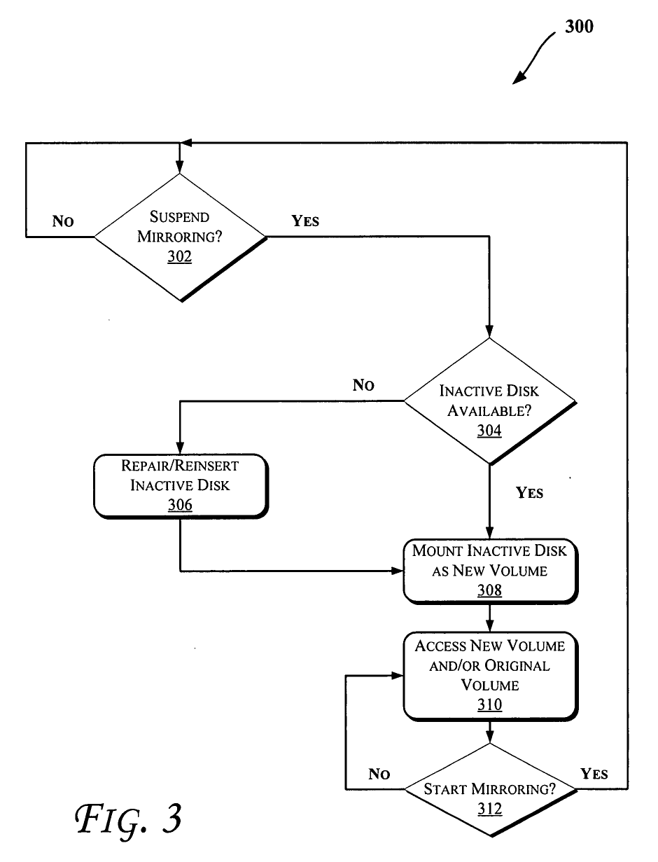

FIGS. 1B and 2 illustrate block diagrams of disk mirroring systems 150 and 200, according to some embodiments. FIG. 3 illustrates a flow diagram of a method 300 to access a snapshot data image of a data mirroring volume, according to an embodiment. In some embodiments, one or more of the components discussed with reference to FIGS. 1A through 2 and/or 4 may be utilized to perform one or more of the operations discussed with reference to method 300.

Referring to FIGS. 11A through 3, at an operation 302, it may be determined whether data mirroring has been suspended. In some embodiments, data mirroring may be suspended due to a suspension command (e.g., received from a user and/or host computer), an error (e.g., a read or write error of a disk that is a member of a data mirroring set), and/or occurrence of an event (such as switching from outlet power to battery). For example, FIG. 1B illustrates a system 150 where mirroring has been suspended by disabling the connection between the mirrored data volume 104 and disk 108. Alternatively this 106 may be inactivated instead of this 108 in response to suspension of the data mirroring. At an operation 304, it may be determined whether the inactive disk (e.g., disk 108 FIG. 1B) is available for accessing (e.g., reading and/or writing). If the inactive disk is unavailable, at an operation 306, the inactive disk may be repaired (e.g., by correcting file system errors, such as file attributes, pointers, etc.). In one embodiment, at operation 306, damaged portions of the inactive disk may be mapped out (for example, removed from an access list indicating the addressable portions of the inactive disk), e.g., such that the operating system executing on the host computer 102 would not attempt to access the damaged portions of the inactive disk. In an embodiment, if operation 306 is unsuccessful, the method 300 may be terminated with an error message. In at least one embodiment, the inactive disk may be unavailable at operation 304 because it has been unplugged (e.g., and put on a shelf to be re-inserted at a later time). In such an embodiment, operation 306 may involve reinserting the inactive disk into the system.

At an operation 308, after the inactive disk becomes available, the inactive disk may be mounted as a new volume, e.g., such that the inactive disk may be accessible by a host computer independently of the previously active disk of the mirroring volume. For example, at operation 308 (e.g., see FIG. 2), a snapshot volume 202 may be provided to allow the host computer 102 to access the disk 108 independent of disk 106 which is accessed through the mirrored data volume 104). At an operation 310, the new volume may be accessed (e.g., snapshot volume 202 may be accessed by the host computer 102). Also, the host computer 102 may continue to have access to the original mirrored volume 104 (e.g., with one disk inactive). Once mirroring is to resume at operation 312 (e.g., due to a user or host command), the previously inactive disk that is mounted as the new volume may be returned to the original mirrored data volume (e.g., volume 104) and the method 300 returns to operation 302. In one embodiment, after operation 302 and prior to operation 312, the mirrored volume (e.g., 104) may operate with a disk inactive and mirroring suspended for a while. Subsequently, the inactive disk may become active (e.g., as a member of the data mirroring set) or otherwise mounted for access by the host computer 102, for example at operations 312 and 308, respectively.

In some embodiments, when mirroring is suspended (at operation 302), the host computer may access the snapshot image (e.g., at operation 310) stored on the inactive disk (e.g., disk 108). The mirrored data volume (e.g., volume 104) may continue using the active disk (e.g., disk 106) as its target disk, as shown in FIG. 1B. For example, the host computer 102 may have a handle A for access to the data volume 104. Without changing that handle, a second (unique) volume may be mounted (e.g., with its own unique handle B) to allow the host computer 102 to use the “inactive” disk (e.g., disk 108) as its target disk, as shown in FIG. 2. The host computer 102 would then see a second distinct volume whose data is the snapshot image of the first volume (the mirrored data volume 104) at the time of the mirror suspension.

Once, the two distinct volumes are accessible to the host computer 102 (after operation 308), the snapshot image volume may be used for various purposes at operation 310. For example, access to the snapshot image data might be used for file compare purposes by the user to have a side-by-side view of file differences since the mirror suspension. It could also be used for file rollback purposes and/or file recovery purposes (e.g., since the user would be able to copy files from the snapshot volume to the first volume). It may further be used for selective data image rollback purposes (e.g., since the user would be able to copy files from the first volume to the snapshot volume before performing a full snapshot disk restore).

In one embodiment, after operation 310 (e.g., once the user is finished accessing the snapshot image volume), the snapshot image volume may be dismounted and its target disk, the “inactive” disk, would again become the inactive data mirror disk of the suspended mirroring volume. As such, the inactive disk (e.g., disk 108) would again be available as part of the mirrored volume 104 for resuming data mirroring or RAID redundancy purposes.

Moreover, the host computer 102 discussed with reference to FIGS. 1A-3 may include various components such as those discussed with reference to FIG. 4. Also, disks 106 and 108 may communicate with the host computer 102 through one or more disk controllers 110 that may be present (e.g., in the form of logic) in one or more of the components discussed with reference to FIG. 4, such as the chipset 406 (or one of its components such as items 408, 420, and/or 424 shown in FIG. 4), etc. More particularly, FIG. 4 illustrates a block diagram of a computing system 400 in accordance with an embodiment of the invention. The computing system 400 may include one or more central processing unit(s) (CPUs) or processors 402-1 through 402-P (which may be referred to herein as “processors 402” or “processor 402”). The processors 402 may communicate via an interconnection network (or bus) 404. The processors 402 may include a general purpose processor, a network processor (that processes data communicated over a computer network 403), or other types of a processor (including a reduced instruction set computer (RISC) processor or a complex instruction set computer (CISC)). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors. In an embodiment, the operations discussed with reference to FIGS. 1A-3 may be performed by one or more components of the system 400.

A chipset 406 may also communicate with the interconnection network 404. The chipset 406 may include a graphics memory control hub (GMCH) 408. The GMCH 408 may include a memory controller 410 that communicates with a memory 412. The memory 412 may store data, including sequences of instructions that are executed by the processor 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 404, such as multiple CPUs and/or multiple system memories.

The GMCH 408 may also include a graphics interface 414 that communicates with a graphics accelerator 416. In one embodiment of the invention, the graphics interface 414 may communicate with the graphics accelerator 416 via an accelerated graphics port (AGP). In an embodiment of the invention, a display (such as a flat panel display, a cathode ray tube (CRT), a projection screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the processor 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and one or more network interface device(s) 430 (which is in communication with the computer network 403). Other devices may communicate via the bus 422. Also, various components (such as the network interface device 430) may communicate with the GMCH 408 in some embodiments of the invention. In addition, the processor 402 and the GMCH 408 may be combined to form a single chip. Furthermore, the graphics accelerator 416 may be included within the GMCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 400 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1A-4, may be implemented as hardware (e.g., logic circuitry), software, firmware, or any combinations thereof, which may be provided as a computer program product, e.g., including a machine-readable or computer-readable medium having stored thereon instructions (or software procedures) used to program a computer (e.g., including a processor) to perform a process discussed herein. The machine-readable medium may include a storage device such as those discussed with respect to FIGS. 1A-4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first data volume accessible by a host computer; and
a second data volume accessible by the host computer,
wherein the second data volume is to comprise data corresponding to a snapshot image of the first data volume prior to a suspension of data mirroring by a data mirroring set comprising:
a first disk accessible by the host computer through the first data volume; and
a second disk accessible by the host computer through the second data volume.

2. The apparatus of claim 1, wherein the second data volume is accessible by the host computer at the same time as the first data volume.

3. The apparatus of claim 1, further comprising a first disk controller to couple the first disk to the host computer.

4. The apparatus of claim 3, wherein the first disk controller is to couple the second disk to the host computer.

5. The apparatus of claim 3, further comprising a second disk controller to couple the second disk to the host computer.

6. The apparatus of claim 1, wherein at least one or more of the first or second disks comprise an Integrated Drive Electronics (IDE) disk, enhanced IDE (EIDE) disk, Small Computer System Interface (SCSI) disk, Fibre Channel disk, Serial Attached SCSI (SAS) disk, universal serial bus (USB) disk, Internet SCSI (iSCSI), or Serial Advanced Technology Attachment (SATA) disk.

7. The apparatus of claim 1, wherein the first disk corresponds to a first disk partition and the second disk corresponds to a second disk partition.

8. The apparatus of claim 1, further comprising logic to suspend the data mirroring.

9. The apparatus of claim 1, further comprising a chipset that comprises the logic.

10. A method comprising:
allowing a host computer to access a first data volume and a second data volume,
wherein the second data volume is to comprise data corresponding to a snapshot image of the first data volume prior to a suspension of data mirroring performed by a data mirroring set comprising:
a first disk accessible by the host computer through the first data volume; and
a second disk accessible by the host computer through the second data volume.

11. The method of claim 10, wherein allowing the host computer to access the second volume is performed without interrupting access by the host computer to the first data volume.

12. The method of claim 10, further comprising removing the second data volume from host access in response to a user command.

13. The method of claim 12, further comprising reconfiguring the second disk to be accessed by the host computer through the first data volume.

14. The method of claim 10, further comprising determining whether the second disk is available prior to mounting it as the second data volume.

15. The method of claim 10, further comprising repairing or reinserting the second disk prior to mounting it as the second data volume.
